(19) United States
(12) Patent Application Publication
(10) Pub. No.: US 2010/0274713 A1
(43) Pub. Date: Oct. 28, 2010

(54) Wireless Trading System And Method Of Using The Same

(76) Inventor: Tun-Ping Wang, Tu-Cheng City (TW)

Correspondence Address: LIN & ASSOCIATES INTELLECTUAL PROPERTY, INC., P.O. BOX 2339, SARATOGA, CA, 95070-0339, US

(21) Appl. No.: 12/430,050

(22) Filed: Apr. 24, 2009

(51) Int. Cl. G06Q 20/00

(52) U.S. Cl. 705/40; 705/35

(57) ABSTRACT

A wireless trading system used for trading by an electronic money card includes a reading device including a reading unit for wirelessly reading account information of the electronic money card and a transmitting unit for transmitting out the account information read by the reading unit, a communication device, a commerce platform for providing the service of trading, and a payment platform for providing the service of paying trading bills. A method of using the above-mentioned wireless trading system includes: the reading device wirelessly reading the account information of the electronic money card and then sending the account information to the communication device, the communication device logging in the commerce platform, some consumption activities being carried out on the commerce platform and bills made by the consumption activities being sent to the payment platform, the payment platform paying for the bills and sending account balance to the communication device, and the communication device modifying the account information of the electronic money card.

### BACKGROUND OF THE INVENTION

1. Field of the Invention

The present invention generally relates to a trading system and a method of using the same, and more particularly to a wireless trading system and a method of using the wireless trading system.

2. The Related Art

With the development of electronic trading technology, various electronic money cards issued by the financial institutions have been widely used in our daily life. The consumer can trade by electronic money of the electronic money card instead of cash taken by the consumer for making the trading conveniently.

When the electronic money card is used in a supermarket or the like, a credit card machine is generally needed to be connected to a commerce platform and a payment platform by a contact or contactless method. Then the electronic money card is handed over to a runner for payment by means of the credit card machine. However, during the payment, some information about the electronic money card is possibly copied or stolen due to the card operated by others so that gives the consumers a poor safeguard.

### SUMMARY OF THE INVENTION

An object of the present invention is to provide a wireless trading system used for trading by means of an electronic money card. The electronic money card includes an induction unit and a memory unit for storing account information. The wireless trading system includes a reading device, a communication device for receiving the account information sent by the reading device, a commerce platform connected to the communication device and logged in by means of the account information in the communication device for providing the service of trading, and a payment platform connected to the commerce platform for paying trading bills. The reading device includes a reading unit and a transmitting unit for transmitting out the account information read by the reading unit. The reading unit is adapted to match with the induction unit of the electronic money card for wirelessly reading the account information stored in the memory unit of the electronic money card.

A method of using the above-mentioned wireless trading system includes the steps of: the reading device wirelessly reading the account information of the electronic money card and then sending the account information to the communication device, the communication device logging in the commerce platform by means of the account information, some consumption activities being carried out on the commerce platform and then the bills made by the consumption activities being sent to the payment platform, the payment platform paying the bills and then sending feedback information to the commerce platform and the communication device respectively, and further sending the account balance to the communication device, and the communication device modifying the account information of the electronic money card through the reading device according to the sent account balance by the payment platform.

As described above, the wireless trading system of the present invention utilizes the reading device to reads the account information of the electronic money card by a contactless means and then sends the read account information to the communication device for the trading operations so that omits the process of handing over the electronic money card to the service personnel and further enhances the trading security and convenience.

### BRIEF DESCRIPTION OF THE DRAWINGS

The present invention will be apparent to those skilled in the art by reading the following description, with reference to the attached drawings, in which:

FIG. 1 is a block diagram of a wireless trading system according to the present invention;

FIG. 2 is a view of an electronic money card;

FIG. 3 is a block diagram of a reading device of the wireless trading system of FIG. 1;

FIG. 4 is a block diagram of a first embodiment of a communication device of the wireless trading system of FIG. 1;

FIG. 5 is a block diagram of a second embodiment of the communication device of the wireless trading system of FIG. 1; and

FIG. 6 is a flow chart showing a method of using the wireless trading system of FIG. 1.

### DETAILED DESCRIPTION OF THE PREFERRED EMBODIMENT

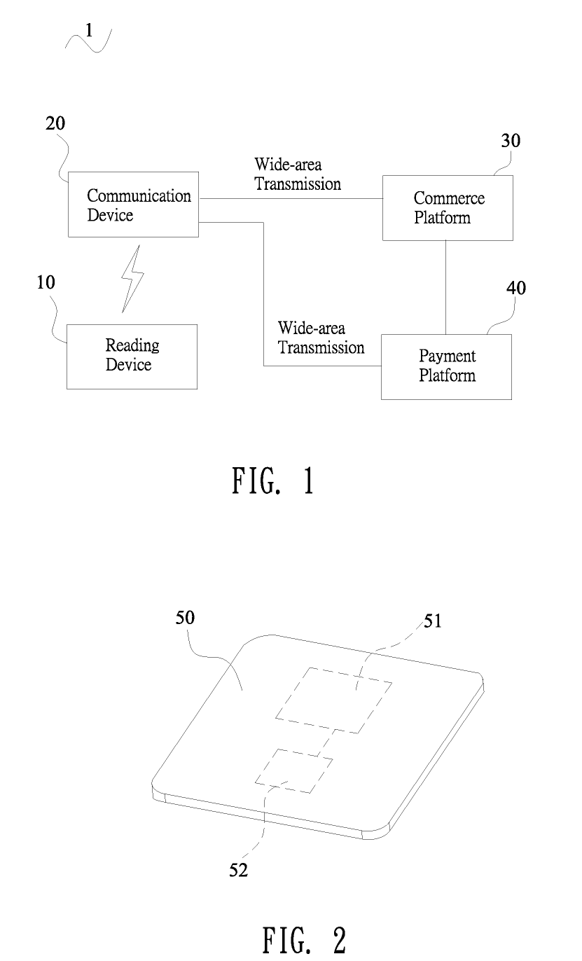

With reference to FIG. 1, a wireless trading system 1 according to the present invention includes a reading device 10, a communication device 20, a commerce platform 30 and a payment platform 40. The wireless trading system 1 is used for trading by means of an electronic money card 50.

Referring to FIG. 2, the electronic money card 50 includes an induction unit 51 and a memory unit 52. The consumer account information is stored in the memory unit 52. The induction unit 51 is generally connected to a card reader module (not shown) for modifying and reading the consumer account information stored in the memory unit 52.

Referring to FIG. 3, the reading device 10 is a wireless device and includes a reading unit 11, a transmitting unit 12 and a power unit 13 for providing a work voltage to the reading device 10. The reading unit 11 is connected to the transmitting unit 12 by a UART (universal asynchronous receiver/transmitter) interface. The reading unit 11 includes a reader 111 and an induction antenna 112. In the embodiment, the reading unit 11 is a NFC (near field communication) chip which has 13.65 MHz work frequency and can generate a range of 10 centimeters electromagnetic field. The transmitting unit 12 includes a processing unit 121 and a transmitting antenna 122. In the embodiment, the transmitting unit 12 is a Bluetooth chip which has 2.4 GHz work frequency and can generate a range of 10˜100 centimeters electromagnetic field. The induction unit 51 of the electronic money card 50 is matched with the induction antenna 112 and can be wirelessly induced by the induction antenna 112 in the appropriate electromagnetic field so as to make the reader 111 wirelessly read the account information stored in the memory unit 52 of the electronic money card 50. The account information is further transmitted to the transmitting unit 12 through the UART interface for being processed by the processing unit 121 and then transmitted out by the transmitting antenna 122.

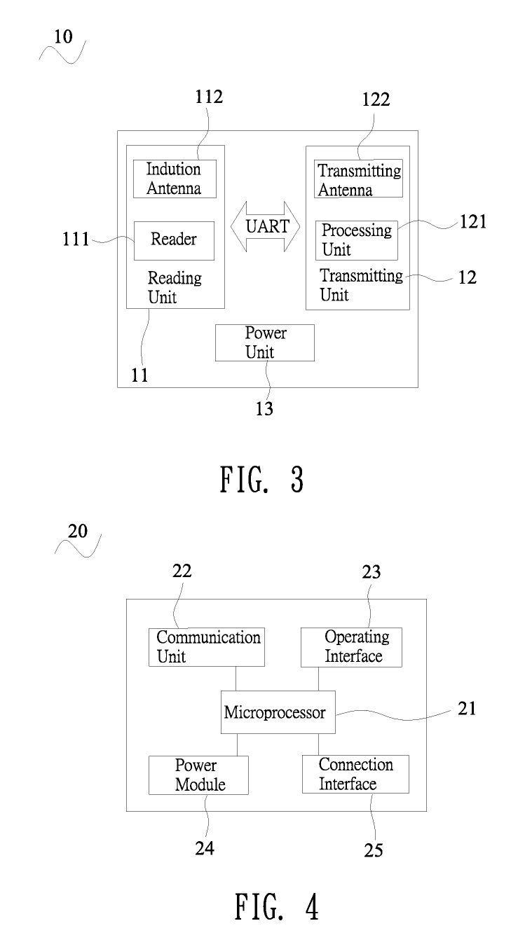

Referring to FIG. 4, the communication device 20 is used to receive the account information of the electronic money card 50 sent by the reading device 10, and then log in the commerce platform 30 for the wireless trading by the account information. A first embodiment of the communication device 20 includes a microprocessor 21, a communication unit 22, an operating interface 23, a power module 24 and a connection interface 25 connected with the microprocessor 21 respectively so as to make the microprocessor 21 overall process data and information in the communication device 20 for further accomplishing the transmitting of the data and information. The power module 24 supplies work power for the communication device 20. The communication unit 22 is used for receiving the account information of the electronic money card 50 sent by the transmitting unit 12 of the reading device 10. In the embodiment, the communication unit 22 is a Bluetooth chip which matches with the Bluetooth chip of the transmitting unit 12 for wirelessly exchanging information with the transmitting unit 12 within the appropriate electromagnetic field. The operating interface 23 may be a keyboard or a handwritten screen and is used for inputting some corresponding operation information, such as user login password, trading selection and so on. The connection interface 25 is connected to the commerce platform 30 either by a wireless transmission interface (such as Bluetooth, Infrared, GPRS, 3G) or by a wired transmission interface (such as USB interface, IEEE 1394 transmission interface).

Referring to FIG. 1 again, the commerce platform 30 of the wireless trading system 1 can be a website providing merchandise or service. The consumers can log in the website for a convenient trading, such as purchasing merchandise or selecting service. When the trading is selected, the commerce platform 30 will send the information of the amount of money spent on the trading to the payment platform 40.

The payment platform 40 is a website of a financial institution which issues the electronic money card 50 and provides some service about the account of the electronic money card 50, such as inquiring account balance, recharging the account and so on. The payment platform 40 is connected to the commerce platform 30 by either a wired transmitting means or a wireless transmitting means for paying the trading amount of money according to the bill information sent by the commerce platform 30. The payment platform 40 is further connected to the communication device 20 by the connection interface 25 for achieving the corresponding service about the electronic money card 50, such as the account inquiry and recharge, according to the account information provided by the communication device 20. Furthermore, the account balance can be rewritten into the electronic money card 50 through the communication device 20 and the reading device 10.

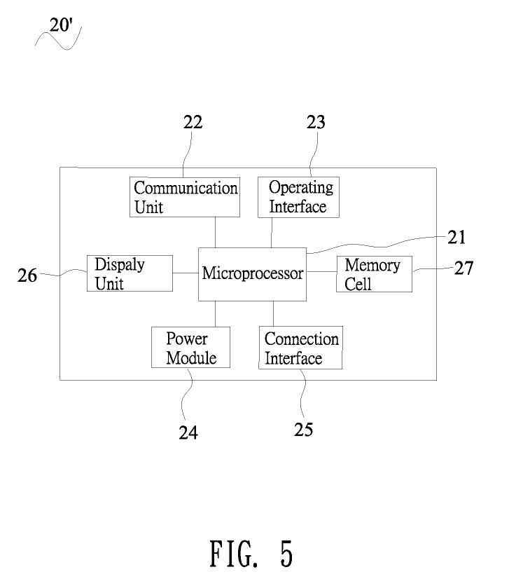

Referring to FIG. 5, a second embodiment of the communication device 20 is shown, wherein the communication device 20 is a mobile phone or a computer and further includes a display unit 26 and a memory cell 27 compared with the first embodiment of the communication device 20. The display unit 26 and the memory cell 27 are respectively connected with the microprocessor 21. The memory cell 27 can store the detailed trading account therein, and the display unit 26 can show the account information of the electronic money card 50 and the detailed trading account thereon so that facilitates the consumers to inquire and check the trading process, the account balance and so on. Besides, both the commerce platform 30 and the payment platform 40 can be also integrated in the communication device 20 for facilitating the consumers to operate.

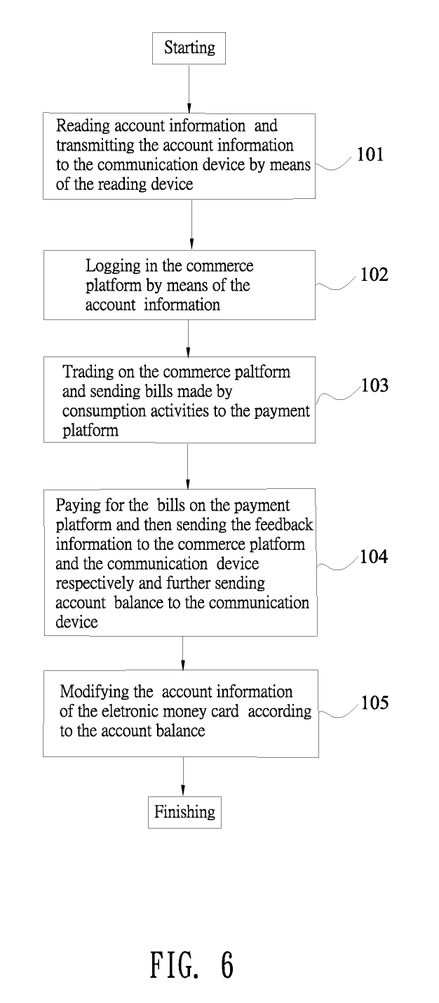

Referring to FIG. 6, a method of using the above-mentioned wireless trading system 1 includes the following steps.

Step 101, the electronic money card 50 is located within the appropriate electromagnetic field of the reading device 10 so as to make the reading unit 11 of the reading device 10 to read the account information of the electronic money card 50 by a contactless method, and then the transmitting unit 12 of the reading device 10 sends the account information to the communication device 20.

Step 102, the communication device 20 logs in the commerce platform 30 by means of the account information sent by the reading device 10 with a method of wide-area transmission, such as wireless network, GPRS, 3G, SMS and so on.

Step 103, some consumption activities, such as shopping, are carried out on the commerce platform 30 and then the bills made by the consumption activities are sent to the payment platform 40.

Step 104, the payment platform 40 pays the consumption amount of money according to the bills sent by the commerce platform 30, and then sends the information that the payment has been completed to the commerce platform 30 and the communication device 20 respectively. The payment platform 40 further sends the account balance to the communication device 20.

Step 105, the communication device 20 modifies the account information of the memory unit 52 of the electronic money card 50 through the reading device 10 according to the sent account balance by the payment platform 40 so as to keep the electronic money card 50 having the consistent account information with the payment platform 40. Then the trading process is finished.

Especially, when the communication device 20 can further provide the service of the commerce platform 30 and the payment platform 40, the trading steps 102˜104 described above can be simultaneously accomplished only by means of the communication device 20.

As described above, the wireless trading system 1 of the present invention utilizes the reading device 10 to reads the account information of the electronic money card 50 by a contactless means and then sends the read account information to the communication device 20 for the trading operations so that omits the process of handing over the electronic money card 50 to the service personnel and further enhances the trading security and convenience.

The forgoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A wireless trading system adapted for trading by means of an electronic money card, the electronic money card including an induction unit and a memory unit for storing account information, the wireless trading system comprising:
a reading device including
a reading unit adapted to be matched with the induction unit of the electronic money card for wirelessly reading the account information stored in the memory unit of the electronic money card, and
a transmitting unit for transmitting out the account information read by the reading unit;
a communication device for receiving the account information sent by the transmitting unit of the reading device;
a commerce platform connected to the communication device and logged in by means of the account information in the communication device for providing the service of trading; and
a payment platform connected to the commerce platform for paying trading bills.

2. The wireless trading system as claimed in claim 1, wherein the reading unit of the reading device is a NFC chip and the transmitting unit of the reading device is a Bluetooth chip.

3. The wireless trading system as claimed in claim 2, wherein the NFC chip of the reading device is connected to the Bluetooth chip of the reading device through a UART interface.

4. The wireless trading system as claimed in claim 1, wherein the communication device is further connected to the payment platform for inquiring the account balance of the electronic money card according to the account information in the communication device.

5. The wireless trading system as claimed in claim 1, wherein both the commerce platform and the payment platform are integrated in the communication device.

6. A method of using the above-mentioned wireless trading system, comprising the steps of:
the reading device wirelessly reading the account information of the electronic money card and then sending the account information to the communication device;
the communication device logging in the commerce platform by means of the account information;
some consumption activities being carried out on the commerce platform and then the bills made by the consumption activities being sent to the payment platform;
the payment platform paying the bills and then sending feedback information to the commerce platform and the communication device respectively, and further sending the account balance to the communication device; and
the communication device modifying the account information of the electronic money card through the reading device according to the sent account balance by the payment platform.
